(19) United States
(12) Patent Application Publication
(10) Pub. No.: US 2013/0068745 A1
(43) Pub. Date: Mar. 21, 2013

(54) GAS SHIELDING DEVICE FOR A WELDING SYSTEM

(71) Applicants: Christopher David Agosti, South Euclid, OH (US); Jeffrey Thomas Nadzam, Westlake, OH (US); Michael Lee Whan, Windham, OH (US); Geoffrey Michael Lipnevicius, Sagamore Hills, OH (US)

(72) Inventors: Christopher David Agosti, South Euclid, OH (US); Jeffrey Thomas Nadzam, Westlake, OH (US); Michael Lee Whan, Windham, OH (US); Geoffrey Michael Lipnevicius, Sagamore Hills, OH (US)

(73) Assignee: LINCOLN GLOBAL, City of Industry, CA (US)

(21) Appl. No.: 13/233,942

(22) Filed: Sep. 15, 2011

(51) Int. Cl. B23K 9/16

(52) U.S. Cl. 219/137.9

(57) ABSTRACT

A welding system moves in a direction of travel, the welding system includes at least one torch directed toward a first location. The at least one torch each contains an electrode used to facilitate a weld, wherein a primary zone surrounds the electrodes in the first location. A secondary zone is located behind the primary zone with respect to the direction of travel, wherein a second gas line delivers shielding gas toward the secondary zone.

### TECHNICAL FIELD

The present disclosure is related to welding, and more particularly, to gas shielding that protects a welding process.

### DISCUSSION OF ART

Arc welding applications are often automated in order to improve productivity. Some automated arc welding applications use multiple welding electrodes to further increase productivity through increased weld travel speeds or weld-metal deposition rates. One such example is the use of two or more gas metal arc welding (GMAW) electrodes at high travel speeds to make long straight weldments. Increased productivity is achieved by welding using multiple welding electrodes, welding power sources and welding arcs while still maintaining a single molten weld pool. In the case of tandem GMAW welding, an integrated torch is employed that contains both sets of welding contact tips and shielding gas diffusers.

The use of conventional systems are associated with various deficiencies. For example, due to the intersection of electrode components, the integrated tandem GMAW torches may vary significantly in design and shape, which often requires custom bracketing when using torch mounted equipment. Furthermore, when welding using the tandem GMAW process, the resulting effect is that the length of the molten weld pool usually increases beyond what is typical for single-torch GMAW. Accordingly, a primary shielding gas envelope dispersed by the welding torch may no longer provide adequate coverage to the molten weld pool or the newly-solidified weld metal that follows immediately behind the progression of the welding torch. Subsequently, due to inadequate shielding gas coverage in this highly-reactive region of the weld metal, the weld joint may yield poor visual appearance with potentially compromised mechanical properties. Systems and methods are needed to overcome these and other deficiencies.

### BRIEF DESCRIPTION

In an embodiment, a welding system moves in a direction of travel, the welding system includes at least one torch directed toward a first location. The at least one torch each contains an electrode used to facilitate a weld, wherein a primary zone surrounds the electrodes in the first location. A secondary zone is located behind the primary zone with respect to the direction of travel, wherein a second gas line delivers shielding gas toward the secondary zone.

In an embodiment, a tandem welding system moves in a direction of travel. The tandem welding system includes a first torch and a second torch, the first torch and the second torch each contain an electrode used to facilitate a weld in the first location. A primary zone surrounds the electrodes, wherein a first gas line delivers shielding gas toward the primary zone. A secondary zone trails the primary zone with respect to the direction of travel, wherein a second gas line delivers shielding gas toward the secondary zone.

In an embodiment, a welding system moves in a direction of travel and includes a plurality of torches, which each contain an electrode used to facilitate a weld. A primary zone surrounds the electrodes and a secondary zone trails the primary zone with respect to the direction of travel. A gas line delivers shielding gas toward the secondary zone. A shield protects the gas line from one or more environmental conditions, the gas line is fixed to the shield. A universal coupler couples the shield to the welding system, the universal coupler facilitates linear and/or rotational movement of the shield.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Reference is made to the accompanying drawings in which particular embodiments and further benefits of the invention are illustrated as described in more detail in the description below, in which:

FIG. 1 is a block diagram of a welding system that includes a welder, which is joined to a secondary gas delivery system via a universal coupler;

FIG. 2 is a detailed block diagram of the welding system shown in FIG. 1 that shows the components within the primary and secondary gas delivery systems and universal coupler;

FIG. 3 is a plan view of an embodiment of the shield used with an exemplary tandem weld system;

FIG. 4 is a perspective view of the universal coupler that is used to couple the shield to a welder;

FIG. 5 is a plan view of a universal coupler that is used to couple the shield to a welder to deliver a trailing shield gas; and

FIG. 6 is an exploded view of the system that facilitates delivery of a trailing shield gas for a welder.

### DETAILED DESCRIPTION

Referring now to the figures, several embodiments or implementations of the present invention are hereinafter described in conjunction with the drawings, wherein like reference numerals are used to refer to like elements throughout and wherein the illustrated structures are not necessarily drawn to scale. The present invention provides an apparatus for delivery of an additional shielding gas to a welding process. This apparatus may be used in order to help improve the performance of a specific welding process and/or the welded joint characteristics. Although illustrated and described hereinafter in the context of exemplary tandem welding systems, the invention is not limited to the illustrated examples and may include any number of welding heads.

The subject embodiments disclose disparate implementations to augment the delivery of shielding gas in a welding system. A universal mounting bracket can be employed to mount a supplemental shielding gas delivery system to single and multiple welding torches. Such bracketing can be adjusted to allow a trailing gas shield to be moved or oriented at different angles for various torch positions, welding joints, and welded component geometries. In an embodiment, an electronically controlled gas flow valve is employed to distribute a desired rate of gas to the weld and area proximate thereto.

The valve can be coupled to an electromechanical switch, which is capable of receiving a signal and converting it into a mechanical result. In one example, the switch is operated by a solenoid, which can open and close the valve. In this embodiment, the switch can be in two states: either fully open or fully closed. In an alternative embodiment, the switch is controlled via a more granular approach, wherein position control can be incorporated to open the valve to a plurality of varying degrees. For example, the valve could be open to allow one of many states including 0%, 20%, 40%, 60%, 80%, and 100%, although substantially any incremental opening level is contemplated.

The position control can be facilitated via a servo motor or similar control to dictate the particular rate of flow through the valve based on various system requirements. To determine the appropriate flow rate and commensurate valve opening, one or more feedback devices can be employed including welding waveform monitors, heat sensors, optical sensors, welder orientation, etc. that relate directly or indirectly to the amount of shielding gas necessary for a suitable weld environment. This information can be processed via a control component to subsequently open the valve to a suitable amount. The gas flow valve can be controlled and operated using robotic input/output (I/O) signals, robotic programmable machine control, or other computer controls.

To deliver supplemental shielding gas to a welding system, a consumable, gas distribution insert can be employed that is easily removed, discarded, and subsequently replaced should the existing insert become damaged or otherwise deficient due to accumulation of weld-metal spatter or other deleterious effects. In an example, the gas distribution insert is made of a porous material that allows gas to permeate readily therethrough, promoting even gas distribution across the surface of the gas distribution insert on the outlet-side of the trail gas shield. For this purpose, the porous gas distribution insert may be manufactured using sintered powder metallurgy or other process to create a porous structure to accommodate the flow of shielding gas. Alternatively, depending on the demands of the welding application, the trail gas shield may also be operated without use of the gas distribution insert.

In addition, a quick-disconnect gas line connection can be employed to facilitate easy removal from operation. In an embodiment, integral shut-off valving can be employed to automatically stop gas flow from a reservoir once the gas line is disconnected. Pneumatic mechanisms known in the art can be employed to close a switch at a location within the gas line (e.g., at or near and endpoint) to discontinue the flow of gas therefrom. This approach can prevent gas from being unnecessarily depleted from a reservoir if the gas line is ultimately disconnected, whether through inadvertent action or conversely through purposeful action such as for maintenance to the welding system. In addition, safety standards can be maintained to prevent accidents from occurring in or around the welding system as a result of gas leakage.

More particularly, the subject embodiments relate to a welding-torch-mounted apparatus that includes a universal adjustable mounting bracket. A supporting gas delivery system and automated controls may be used for the purpose of providing secondary gas shielding (e.g., trailing, external, back, or otherwise supplementary gas shielding) during various welding processes and other multiple-head welding processes. The subject embodiments disclosed herein allow for programmable, automated delivery of a separate shielding gas supply (e.g., an inert gas such as 100% argon or a combination of inert and active gases) that may be transported via dedicated supply plumbing and control valving (e.g., solenoid actuated valve), subsequently dispersing this secondary shielding gas local to the region of the weld that remains reactive with the ambient atmosphere, even after the welding torch and the primary shielding gas have moved away from this reactive region as part of the natural progression of the welding process. The volumetric flow rate of shielding gas distribution may be controlled via a gas flow valve that is operated using logical robotic or computer programming.

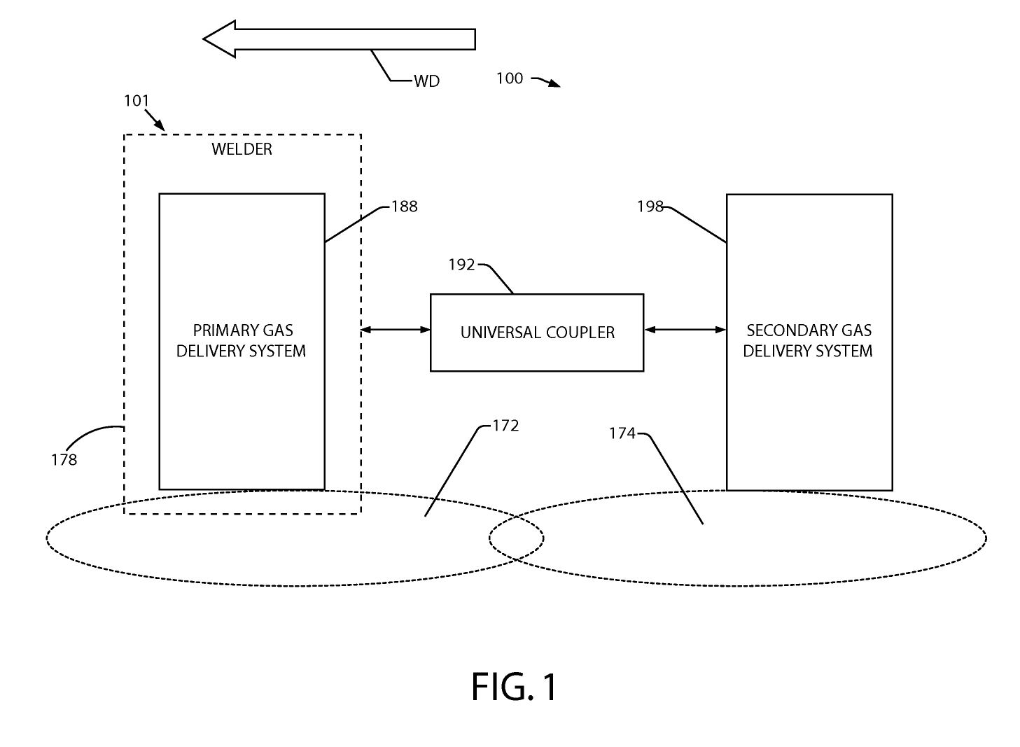

Referring now to the drawings wherein the showings are for the purpose of illustrating the exemplary embodiments, FIG. 1 shows a welding system 100 that is generally employed to facilitate the welding of materials in a controlled environment. The welding system 100 includes a welder 101 that employs gas metal arc (MIG), gas tungsten arc (TIG), or other weld technology that uses shielding gas. In this manner, the weld area can be protected from ambient gases which can reduce the quality of the weld, such as oxygen, nitrogen, carbon dioxide, and water vapor. Failure to use a shielding gas can lead to deleterious effects such as a porous and weak weld and/or excessive spatter.

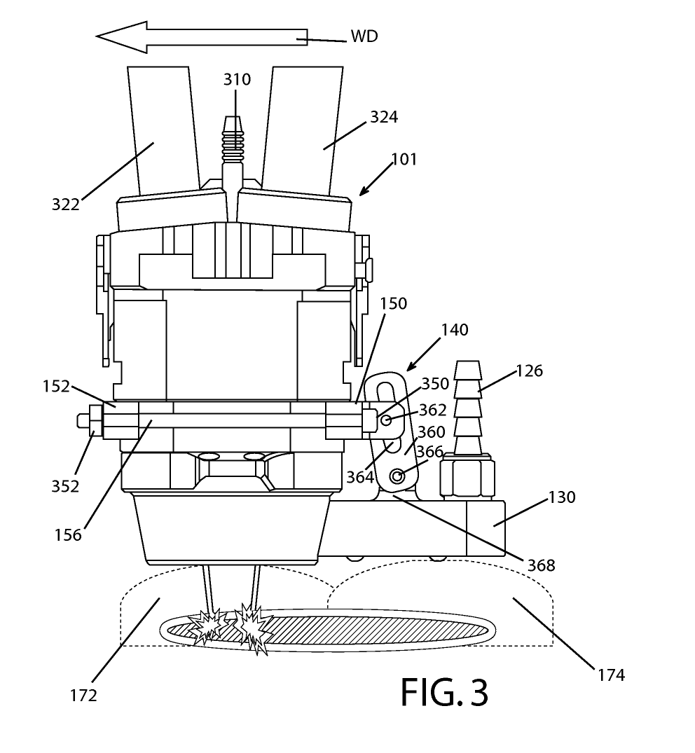

In an embodiment, the welding system 100 is mobile and travels in a direction WD. As shown in FIG. 3, the weld system can have one or more torches 322, 324 that each use electrodes fed to a primary zone 172 to facilitate a weld operation. In order to mitigate sub-standard results, the welding system 100 includes a primary gas delivery system 188 that distributes shielding gas into the primary zone 172 and a secondary gas delivery system 198 that distributes shielding gas into a secondary zone 174. In an embodiment, the primary gas delivery system 188 is incorporated into the welder 101, which is off-the-shelf. In this example, the secondary zone 174 trails the primary zone 172 with respect to the travel direction WD. The secondary zone 174 can be disposed in substantially any location with respect to the primary zone 172 and direction WD, however, to provide a suitable welding environment.

Although the exemplary embodiments show a single secondary gas delivery system, it will be appreciated by one skilled in the art that a plurality of gas delivery systems can be concurrently employed for controlled delivery of gas proximate a weld operation. Moreover, each gas delivery system can employ a universal coupler, wherein a plurality of distribution points are employed for each gas delivery system. Accordingly, the systems and methods described herein can be scaled to provide gas at particular and varying flow rates at disparate locations to create a desired footprint of gas delivery proximate a weld.

A universal coupler 192 is utilized to join the secondary gas delivery system 198 to the welder 101. In an embodiment, the welder 101 is purchased as an off-the-shelf product that has known dimensions for size and shape. For example, a make and model for a single electrode GMAW welder can have particular dimensions for length, width, circumference, etc. In one example, the same manufacturer can produce a tandem electrode GMAW welder that has dimensions that vary in known quantities from the single electrode GMAW welder model. The universal coupler 192 overcomes such dimensional inconsistencies by joining the secondary gas delivery system to the welder 101 regardless of size and/or shape. In this manner, the secondary gas delivery system can be joined to any welder to increase an envelope of shielding gas to create an optimal weld environment.

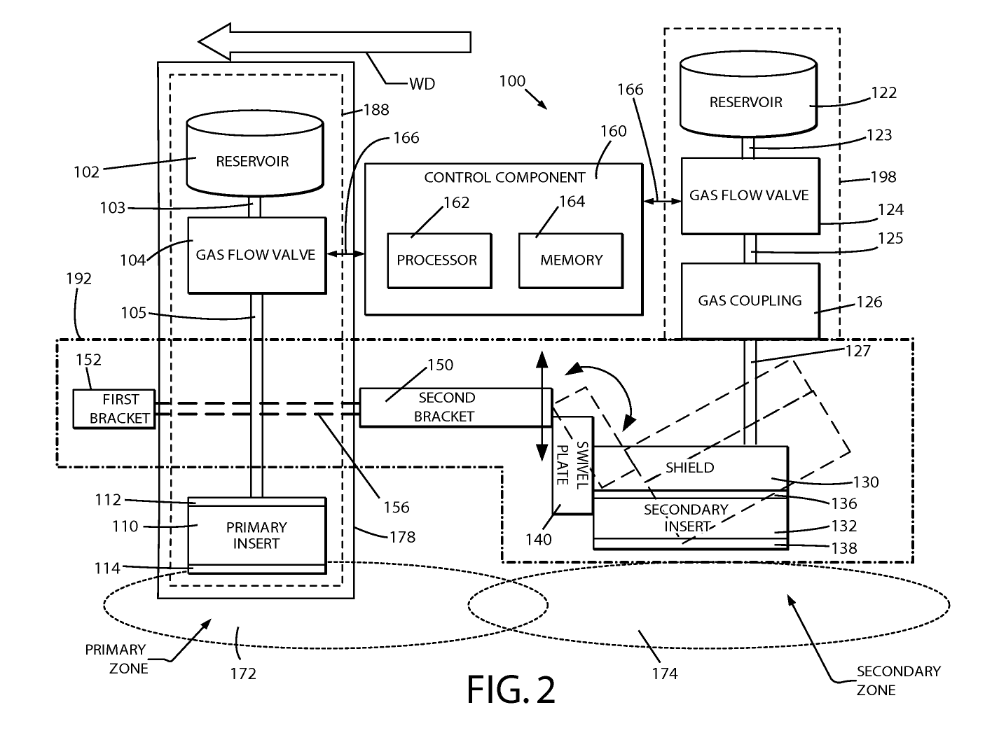

FIG. 2 provides a detailed view of the welding system 100 described above. The primary gas delivery system 188 includes a reservoir 102, a gas flow valve 104, and a primary insert 110. The primary gas delivery system 188 can be disposed proximate to one or more wire feed systems (not shown) that deliver a consumable electrode(s) to the weld area on demand. For the sake of brevity, however, the weld process in general and wire delivery in particular is not described in further detail herein as such technology is well understood by one skilled in the art. The primary gas delivery system 188 can be partially or completely disposed within a housing 178, which is made of a material to protect components therein from a generally harsh environment. The housing 178 can have varying dimensions that are commensurate with welding technology, number of electrodes, volume of shielding gas, and/or one or more other factors. The housing 178 can also include a wide range of radii, varying protrusions, and other inconsistent surface anomalies from weld system to weld system.

A gas line 103 facilitates delivery of gas from the reservoir 102 to the gas flow valve 104 and a gas line 105 facilitates delivery of gas from the gas flow valve 104 to the primary insert 110. FIG. 3 illustrates a gas inlet 310 that can be used to facilitate delivery of gas from the reservoir to the gas flow valve 104. The reservoir 102 is utilized to store shielding gas at a predetermined range of pressure, temperature, and density. In an example, the shielding gas within the reservoir is inert such as helium and argon, which can be used for the welding of non-ferrous materials. Alternatively or in addition, semi-inert gas such as carbon dioxide, oxygen, nitrogen, and/or hydrogen is employed to contribute to high weld quality. When opened, the gas flow valve 104 is employed to release gas from the reservoir 102 for delivery to the insert 110. The gas flow valve 104 can include a solenoid, servo or other mechanism (not shown) to open and close the valve based on a signal sent from a control component 160.

In this exemplary embodiment, a primary insert 110 is disposed proximate to a weld location within the primary zone 172 wherein one or more electrodes are consumed in a weld pool to form a weld. A secondary insert 132 is disposed in a second location that trails the primary insert with respect to the direction of travel WD. The inserts 110, 132 distribute gas within a primary zone 172 and a secondary zone 174 respectively, wherein the zones 172, 174 may have a percentage overlap with respect to each other. In this manner, the zones 172, 174 extend the area protected from atmospheric conditions thereby allowing a larger weld operation to take place and/or allow increased speed along the direction WD.

The primary insert 110 can be made of inexpensive, yet durable material such as stainless steel or similar metal. The primary insert 110 can be coupled to the welder 101 to facilitate repetitive removal and replacement as needed should the existing insert 110 become damaged or otherwise deficient (e.g., due to the accumulation of weld-metal splatter). In an example, tabs, pins or other fasteners can be employed to allow a user to swap out insert 110 as necessary. The primary insert 110 is designed to receive gas via a primary input 112, which is distributed from the primary insert 110 via a primary output 114. For this purpose, a plurality of vents or other apertures can sized and disposed in a desired geometry within the input 112, the output 114 and/or the primary insert 110 to facilitate an appropriate zone size, gas concentration, and/or other parameters to create suitable weld conditions.

The secondary gas delivery system 198 includes a reservoir 122, a gas flow valve 124, a coupling 110, which is coupled to the secondary insert 132 for delivery to the secondary zone 174. In one embodiment, the reservoir 122 is the same as the reservoir 102 wherein gas is delivered to both the primary and the secondary gas delivery systems from a common source. A gas line 123 facilitates delivery of gas from the reservoir 122 to the gas flow valve 124 and a gas line 125 facilitates delivery of gas from the gas flow valve 124 to the gas coupling 126. The gas coupling 126 can be a quick disconnect or other device that allows gas from the reservoir to be readily connected for distribution of gas to the secondary insert 132. Such gas can be received via a secondary input 136 and distributed via a secondary output 138 as discussed with regard to the primary insert above.

The gas flow valve 124 is opened via the control component 160 when delivery of gas is desired. The valve 124 can include a solenoid that is mechanically opened and closed based on a signal input from the control component 160, as discussed above with reference to the gas flow valve 104. The valve 124 can also be opened and closed incrementally in varying degrees based on any number of factors including the number of other secondary gas delivery systems and/or distribution points, weld environment and requirements, type of gas utilized, overall volume of gas required, speed of welding system, etc. The valve can also be opened or closed on a periodic basis commensurate with changing needs.

In one embodiment, the control component 160 is a computer operable to execute the disclosed architecture. In order to provide additional context for various aspects of the present invention, the following discussion is intended to provide a brief, general description of a suitable computing environment in which the various aspects of the present invention may be implemented. The control component 160 can employ computer-executable instructions that may run on one or more computers, implemented in combination with other program modules, and/or as a combination of hardware and software. Generally, program modules include routines, programs, components, data structures, etc., that perform particular tasks or implement particular abstract data types. For example, such programs and computer-executable instructions can be processed via a robot using various machine control paradigms.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices.

The control component 160 can utilize an exemplary environment for implementing various aspects of the invention including a computer, wherein the computer includes a processor 162, a memory 164 and a system bus 166 for communication purposes. The system bus 166 couples system components including, but not limited to the memory 164 to the processor 162. The processor 162 may be any of various commercially available processors. Dual microprocessors and other multi-processor architectures also can be employed as the processor 162.

The system bus 166 can be any of several types of bus structure including a memory bus or memory controller, a peripheral bus and a local bus using any of a variety of commercially available bus architectures. The memory 164 can include read only memory (ROM) and random access memory (RAM). A basic input/output system (BIOS), containing the basic routines that help to transfer information between elements within the control component 160, such as during start-up, is stored in the ROM.

The control component 160 can further include a hard disk drive, a magnetic disk drive, e.g., to read from or write to a removable disk, and an optical disk drive, e.g., for reading a CD-ROM disk or to read from or write to other optical media. The control component 160 can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the control component 160.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

A number of program modules may be stored in the drives and RAM, including an operating system, one or more application programs, other program modules, and program data. The operating system in the control component 160 can be any of a number of commercially available operating systems.

In addition, a user may enter commands and information into the computer through a keyboard and a pointing device, such as a mouse. Other input devices may include a microphone, an IR remote control, a track ball, a pen input device, a joystick, a game pad, a digitizing tablet, a satellite dish, a scanner, or the like. These and other input devices are often connected to the processor through a serial port interface that is coupled to the system bus, but may be connected by other interfaces, such as a parallel port, a game port, a universal serial bus (“USB”), an IR interface, and/or various wireless technologies. A monitor (not shown) or other type of display device, may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display (not shown) can be employed with the control component 160 to present data that is electronically received from the processor. For example, the display can be an LCD, plasma, CRT, etc. monitor that presents data electronically. Alternatively or in addition, the display can present received data in a hard copy format such as a printer, facsimile, plotter etc. The display can present data in any color and can receive data from the control component 160 via any wireless or hard wire protocol and/or standard.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

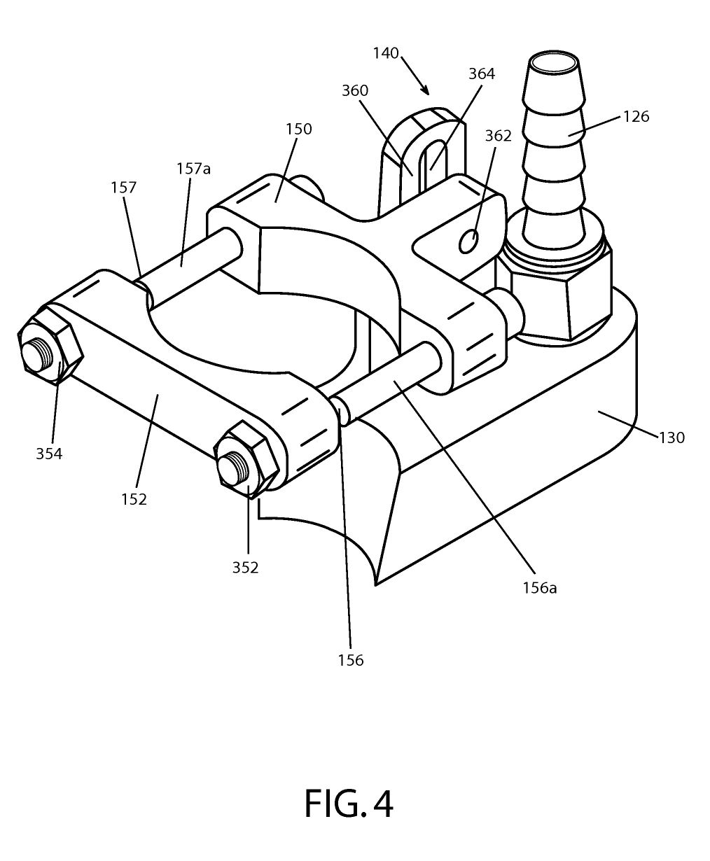

The universal coupler 192 includes a first bracket 152 and a second bracket 150 that are fixed to the welder housing 178 via one or more fasteners 156. The brackets 150, 152 may be shaped to easily adapt to the contour of disparate welder models that have a wide range of dimensional attributes. In an embodiment, both brackets 150, 152 include a crescent shaped feature as depicted in FIG. 4, to accommodate a wide range of housing radii. The fasteners 156, 157 can be disposed within sleeves 156a, 157a respectively provide a desired spacing between the brackets 150, 152 in relation to the housing 178.

Referring back to FIG. 2, a shield 130 (and secondary insert 132 coupled thereto) is joined to the second bracket 150 via a swivel plate 140. The shield 130 provides protection for the gas coupling 126 and associated components to insure they are not damaged during the welding process. The shield can be made of steel, copper, or other material that can withstand heat in greater proportion than material such as bronze, which is generally employed for gas fittings, such as the gas coupling 126. Selection of material can be based on other factors including ease of weld-metal spatter removal, as spatter may accumulate in the region near the primary zone 172 and secondary zone 174 due to the harsh welding environment. In similarity to the brackets 150,152, the shield can also include a shaped feature that is consistent with the shape of the welder housing 178 surface.

The swivel plate 140 facilitates both linear motion and rotational motion of the shield/secondary insert assembly with regard to the second bracket 150. An exemplary alternative location for the assembly is depicted in dashed lines. Such motion can be accomplished by the use of one or more mechanical components to couple the swivel plate 140 to the assembly and the second bracket 150. The components within the universal coupler can be made of a material suitable for welding environments including metal and/or composite materials. In an example, the swivel plate (and surrounding components) are enclosed in a sheath, sleeve, or similar enclosure to minimize the dust, dirt, and debris from fouling the mechanism.

In an embodiment, as shown in FIGS. 3, 4 and 5, the swivel plate is coupled to the assembly via a pin 366 that is disposed within a vertical protrusion 368 on the shield 130. The swivel plate also includes a slot 364, centrally disposed within body 360, to accommodate a pin 362 for linear and/or rotational movement with regard to the second bracket 150. In this manner, the shield can be positioned as appropriate to provide a desired location for the secondary zone 174. In one example, the welder travels around a circumference of a pipe, wherein protection is necessary at an angle commensurate with the pipe radius. In another example, the welder travels along a contoured or stepped surface that requires protection that is different than a zero degree configuration for the shield assembly. It is to be appreciated that a zero degree configuration is illustrated in at least FIG. 3 of the disclosed embodiments.

Other components beyond those described herein to facilitate both linear and rotational motion are within the scope of the subject embodiments, including one or more plates, slots, screws, pins, and other suitable components and configurations. Utilizing such embodiments, the universal coupler can facilitate a rotation from 0-180 degrees and associated linear movement. In an alternate embodiment, the secondary insert and assembly can be fixed orthogonally with regard to the primary insert via the universal coupler 192 to provide a disparate location for the secondary zone 174. Rotation from a zero degree location can be in a counterclockwise direction in one embodiment.

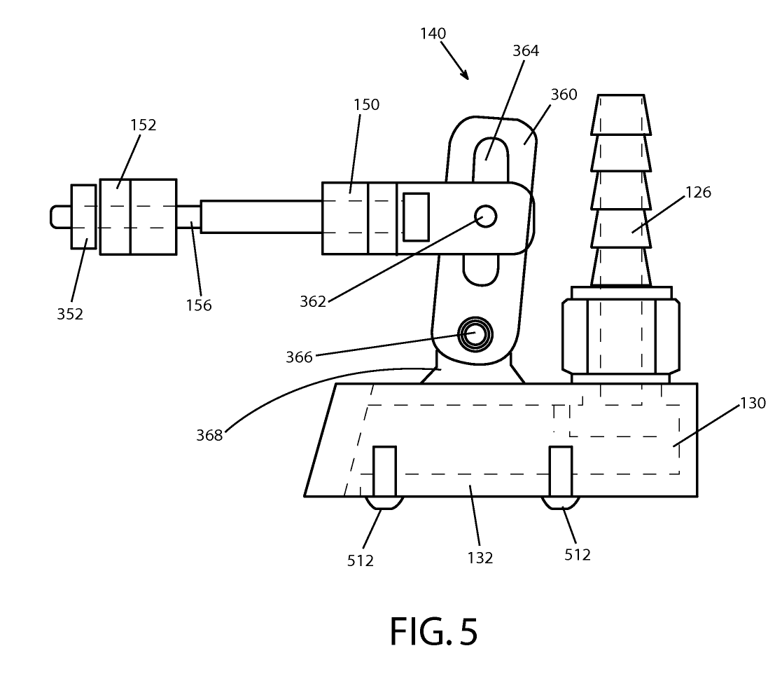

FIG. 5 also illustrates an exemplary configuration for the secondary insert 132 with regard to the shield 130. In this example, the secondary insert 132 is fixed to the bottom of the shield 130 via one or more screws 512. When the secondary insert 132 is replaced, the screws 512 can be easily removed which are replaced when a substitute insert is inserted into the same location. Alternatively or in addition, the surface can be redressed by grinding or similar process in place of insert removal. Yet another option to replacement is to remove and flip the insert to expose a new surface to the weld environment. All of these methods can provide an extended life for the insert beyond that typically found in conventional systems.

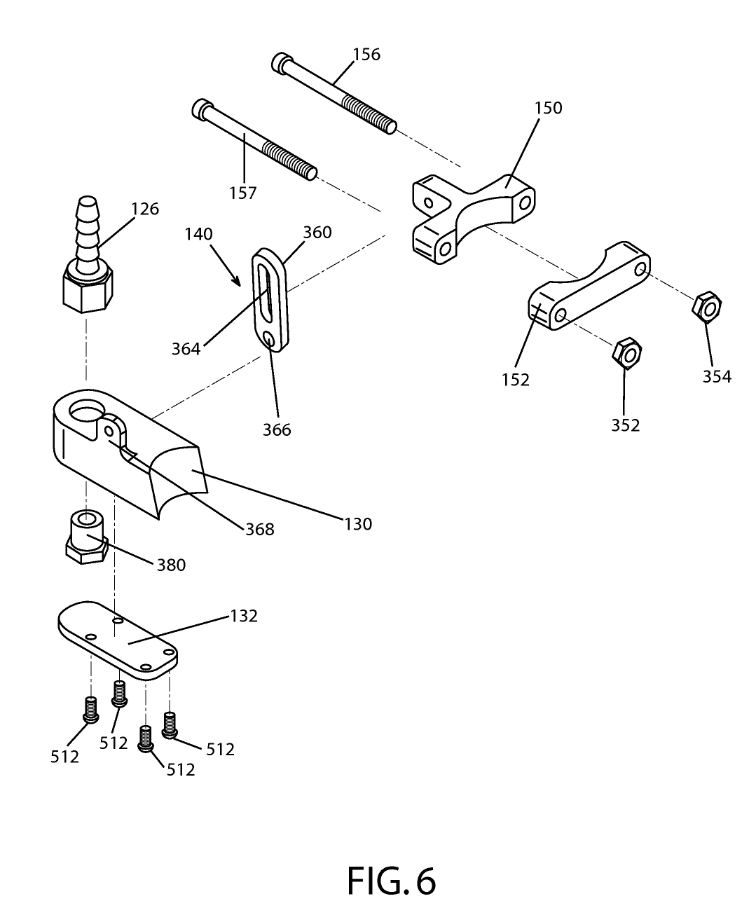

FIG. 6 provides additional detail for this exemplary configuration, wherein a breather vent 380 is shown to interface with the gas coupling 126 within the shield 130 to deliver gas from the reservoir to the secondary insert. As shown, the shield 130 not only protects the gas line and coupling from the weld environment, it also acts as a manifold to ultimately deliver gas to the secondary or other zones. In an embodiment, the gas moves from the gas line through the coupling and into the breather vent 380. From there, gas is distributed through the porous or semi-porous insert 132 and on to the secondary (or other) zone.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

What is claimed is:

1. A welding system that moves in a direction of travel, comprising:
at least one torch directed toward a first location, the at least one torch each contains an electrode used to facilitate a weld in the first location;
a primary zone that surrounds the electrodes in the first location;
a secondary zone that is located behind the primary zone with respect to the direction of travel; and
a second gas line that delivers shielding gas toward the secondary zone.

2. The welding system of claim 1, further including:
a primary gas line that delivers shielding gas toward the primary zone; and
a primary insert that distributes gas from the first gas line toward the primary zone.

3. The welding system of claim 2, further including:
a secondary insert that distributes gas from the second gas line toward the secondary zone.

4. The welding system of claim 3, further including:
a universal coupler that mounts to the welding system, the universal coupler fixes the secondary insert in space relative to the secondary zone.

5. The welding system of claim 4, the universal coupler further including:
a first bracket disposed on a first side of the welding system;
a second bracket disposed on a second side of the welding system proximate the second gas line; and
one or more fasteners that fasten the first bracket to the second bracket to couple the universal coupler to the welding system.

6. The welding system of claim 5, the universal coupler further including:
a gas coupling that fixes the second gas line in place.

7. The welding system of claim 6, further including:
a vent fitting that guides gas from the gas coupling to the secondary insert.

8. The welding system of claim 6, the universal coupler further including:
a shield that protects the second gas line and the gas coupling from one or more environmental conditions.

9. The welding system of claim 8, the universal coupler further including:
a swivel plate that couples the shield to the second bracket, the swivel plate facilitates linear and/or rotational movement of the shield.

10. The welding system of claim 1, wherein the welding system includes at least one GMAW or GTAW welder.

11. The welding system of claim 2, wherein the primary insert is removably coupled to the welding system.

12. The welding system of claim 3, wherein the secondary insert is removably coupled to the welding system.

13. The welding system of claim 3, further including:
a first reservoir that stores shielding gas;
a first gas flow valve that allows gas to flow from the first reservoir to the primary insert;
a second reservoir that stores shielding gas; and
a second gas flow valve that allows gas to flow from the second reservoir to the secondary insert.

14. The welding system of claim 3, further including:
a gas coupling that couples the second gas flow valve to the secondary insert; and
a quick disconnect component that is disposed within the gas line to turn off delivery of gas from the second reservoir when the gas line is disconnected from the gas coupling.

15. The welding system of claim 13, wherein the first gas flow valve and the second gas flow valve are opened and closed via a solenoid, servo or an actuator.

16. The welding system of claim 15, wherein the solenoid in the first gas flow valve and the solenoid in the second gas flow valve are actuated via a control component.

17. A tandem welding system that moves in a direction of travel, comprising:
a first torch and a second torch, the first torch and the second torch each contain an electrode used to facilitate a weld in the first location;
a primary zone that surrounds the electrodes;
a first gas line that delivers shielding gas toward the primary zone;
a secondary zone that trails the primary zone with respect to the direction of travel; and
a second gas line that delivers shielding gas toward the secondary zone.

18. The welding system of claim 17, further including:
a primary insert that distributes gas from the first gas line toward the primary zone; and
a secondary insert that distributes gas from the second gas line toward the secondary zone; and
a universal coupler that mounts to the welding system, the universal coupler fixes one or more gas distribution points in space relative to the secondary zone.

19. The welding system of claim 18, the universal coupler further including:
a first bracket disposed on a first side of the welding system;
a second bracket disposed on a second side of the welding system proximate the second gas line;
one or more fasteners that fasten the first bracket to the second bracket to couple the universal coupler to the welding system;
a shield that protects the second gas line from one or more environmental conditions; and
a swivel plate that couples the shield to the second bracket, the swivel plate facilitates linear and/or rotational movement of the shield.

20. A welding system that moves in a direction of travel, comprising:
a plurality of torches, which each contain an electrode used to facilitate a weld;
a primary zone that surrounds the electrodes;
a secondary zone that trails the primary zone with respect to the direction of travel;
a gas line that delivers shielding gas toward the secondary zone;
a shield that protects the gas line from one or more environmental conditions, the gas line is fixed to the shield; and
a universal coupler that couples the shield to the welding system, the universal coupler facilitates linear and/or rotational movement of the shield.
